(19) United States
(12) Patent Application Publication
(10) Pub. No.: US 2002/0062977 A1
(43) Pub. Date: May 30, 2002

(54) Drop cable sealing adapter

(76) Inventors: Jennifer A. Battey, Euless, TX (US); Steve A. Fontaine, Ft. Worth, TX (US)

Correspondence Address: CORNING CABLE SYSTEMS LLC, P O BOX 489, HICKORY, NC, 28603, US

(21) Appl. No.: 09/725,613

(22) Filed: Nov. 29, 2000

(51) Int. Cl. H02G 3/06

(52) U.S. Cl. 174/93

(57) ABSTRACT

An adapter is used to seal a cable that has a non-cylindrical cross section within a cylindrical port formed in the wall of an enclosure. The adapter has a cylindrical exterior, opposed ends and at least one slot extending between the ends. Preferably, the slot is open to the cylindrical exterior of the adapter. The cable is positioned within the slot, and a sealing substance fills the voids between the cable and the slot. A deformable seal surrounds the adapter and seals the adapter within the cylindrical port of the wall.

### BACKGROUND OF THE INVENTION

This invention relates in general to sealing a cable within a passage extending through a wall of an enclosure, and more particularly, to sealing a communications cable having a non-cylindrical cross section within a cylindrical port extending through the end cap of a splice closure.

### DESCRIPTION OF THE PRIOR ART

There are a wide variety of applications for cables that must be sealed as they pass through a wall of an enclosure. For example, in communications systems, splice closures are utilized along a fiber optic distribution and transmission network for holding and protecting splices. A splice closure typically has a frame with an end cap on one or both ends, and a removable shroud that covers the frame. Splice organizers are mounted to the frame for holding splices between drop cables and a feeder cable. The drop cables and feeder cable extend through cylindrical ports formed in the end cap. The closure is often exposed to deleterious conditions, such as weather, dust, and insect and rodent infestations, thus it is important to seal the drop cables and feeder cable as they pass through the end cap.

The pre-formed ports in the end cap of the splice closure are typically cylindrical holes. The most common type of communications cable presently utilized in splice closures has a cylindrical cross section. An elastomeric gasket or gel surrounds the cable in the port to seal the cable within the port. However, other types of communications cables having non-cylindrical cross sections, such as flat or elliptical, are increasingly being utilized in enclosures, and particularly, in splice closures. An example of such a communications cable is typically used for drop cables and has generally flat sides and rounded, such as semicircular, ends. This cable does not seal well in cylindrical ports due to the difference in cross sectional configurations.

### SUMMARY OF THE INVENTION

In this invention, a communications cable having a non-cylindrical cross section is sealed within a port having a cylindrical cross section that is formed in the end cap of a splice closure. The difference in the cross sectional configurations of the cable and the port is accommodated by an adapter that has a cylindrical exterior for forming a tight fitting seal with the port. The adapter has opposed ends and a length between the ends that is typically greater than the diameter of the adapter. The adapter has at least one passage therethrough for receiving the cable. The passage has a non-cylindrical cross section that generally conforms with the cross section of the cable. A sealing substance, such as an elastomeric gel or grease, surrounds the cable within the passage. A deformable seal surrounds the cylindrical exterior of the adapter to seal the adapter within the cylindrical port.

In the preferred embodiment, the passage comprises an elongate slot that extends inwardly from the exterior surface of the adapter. The slot has two opposed, lengthwise, generally parallel side walls. The slot generally conforms to the cross-section of the cable, which has a major axis that is greater than its minor axis. Preferably, the adapter is made of a rigid plastic material. Also, preferably there is more than one slot, each slot having a depth (which corresponds to the major axis of the cable) that is greater than its width (which corresponds to the minor axis of the cable).

A second embodiment is particularly useful for a non-cylindrical cable that has an exterior metallic sheath. The side walls of the slot include teeth for gripping the cable. The teeth are formed on metallic plates that are mounted to the side walls of the slot. The teeth form a conductive path between the sheath of the cable and the plates to provide a ground for the cable.

### BRIEF DESCRIPTION OF THE DRAWINGS

FIG. 1 is a perspective view of an adapter constructed in accordance with the invention showing a pair of communications cables aligned within a corresponding pair of slots formed in the adapter.

FIG. 2 is a crosswise sectional view of the adapter of FIG. 1 shown installed within a cylindrical port formed in the wall of an enclosure.

FIG. 3 is an enlarged crosswise sectional view of one of the pair of communications cables of FIG. 1.

FIG. 4 is a lengthwise sectional view of the adapter of FIG. 1, taken along the line 4-4 of FIG. 2, showing the pair of communications cables positioned within the slots formed in the adapter.

FIG. 5 is a lengthwise sectional view of the adapter of FIG. 1, taken along the line 5-5 of FIG. 2, showing one of the pair of communications cables positioned within a corresponding one of the slots formed in the adapter.

FIG. 6 is an exploded perspective view of a splice closure having an adapter according to the invention positioned within two of the cylindrical ports formed in the end cap of the closure.

FIG. 7 is a lengthwise sectional view of an alternate embodiment of the adapter of FIG. 1, taken in the same direction as the lengthwise sectional view of FIG. 5, with the communications cable removed for clarity.

### DETAILED DESCRIPTION OF THE PREFERRED EMBODIMENTS

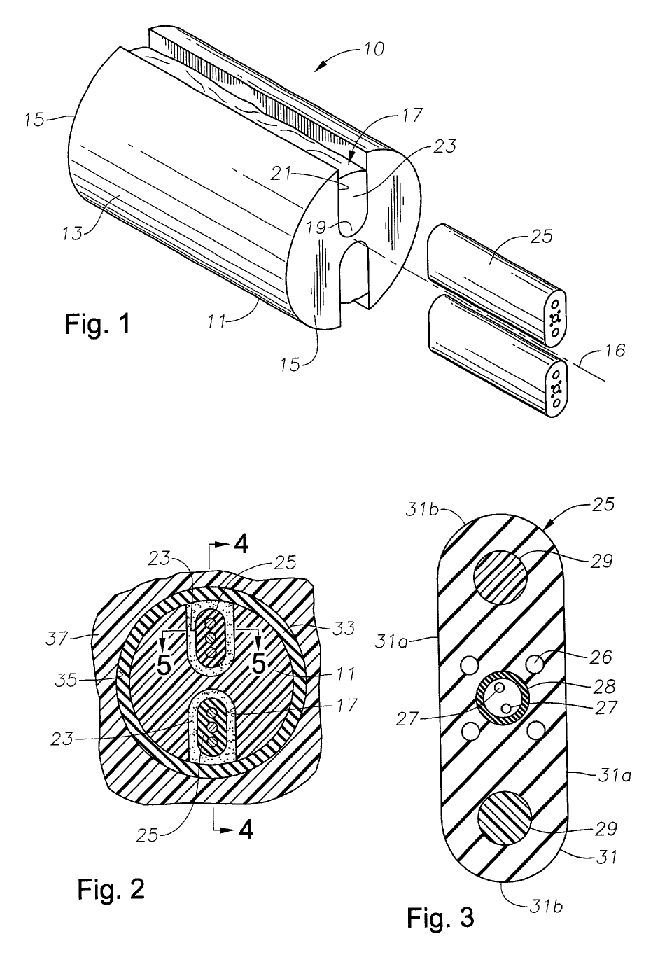

Referring to FIG. 1, an adapter 10 constructed in accordance with the invention comprises an elongate, substantially rigid body 11 preferably made of a hard plastic material. Adapter 10 has a cylindrical exterior 13 and two ends 15 (one shown). Ends 15 are generally flat and face in opposite directions relative to a longitudinal axis 16 defined by the body 11 of the adapter 10.

At least one lengthwise slot 17 extends continuously through body 11 parallel to axis 16 from one end 15 to the other end 15. In the preferred embodiments shown and described herein, there are two slots 17, each forming a separate passage through adapter 10. Adapter 10 has at least one slot 17 formed therein, but may have any number of slots arranged in any desired pattern or configuration. As shown, each slot 17 extends inwardly from exterior 13 and has a base 19 spaced radially outward from axis 16. However, slot 17 of adapter 10 does not necessarily extend inwardly from exterior 13, and instead, may be formed entirely within body 11, for example by machining or molding. A pair of opposed side walls 21 extend outwardly from base 19 to cylindrical exterior 13. Side walls 21 are lengthwise, preferably smooth, and flat surfaces that are generally parallel to one another. Base 19 is preferably curved, or rounded, for example in a semi-circular or elliptical shape. The intersection between base 19 and each side wall 21 is thus curved in the form of a fillet radius. The depth of each slot 17, as measured by the distance from cylindrical exterior 13 to base 19, is considerably greater than the width of the slot 17, as measured by the distance between the side walls 21. In one preferred embodiment, the depth of the slot 17 is about twice the width of the slot 17. However, the depth and the width of the slot 17 may vary considerably such that the slot 17 has any desired non-cylindrical cross section. As shown and described herein, a line bisecting side walls 21 passes through longitudinal axis 16 so that each slot 17 is identical to the other and the adapter 10 is symmetrical about axis 16. However, the slots 17 need not be identical and the adapter 10 need not be symmetrical about longitudinal axis 16. Furthermore, the non-cylindrical shapes of the slots 17 need not be the same.

A communications cable 25 is adapted to be received within each slot 17 and sealed with an elastomeric sealing substance 23, such as a conventional silicone-based gel or grease. Preferably, sealing substance 23 is of a type that is pre-cured, tacky and is encased within a release film that is removed at the time the cable 25 is positioned within the slot 17. Initially, sealing substance 23 will be placed within slot 17 to a partially filled level, and then cable 25 will be submerged in sealing substance 23. Cable 25 has a non-cylindrical cross section and may be of a variety of conventional types, such as fiber optic, copper, or composite. The cable 25 shown in FIG. 3 and described herein has a plurality of optical fibers 27 located lengthwise within a common buffer tube 28. Typically, there will be from about 2-12 optical fibers 27 located within buffer tube 28. A pair of lengthwise extending strengthening members 29 are located on opposite sides of buffer tube 28. Strengthening members 29 may, for example, be formed of metal or high tensile strength fibers in a composite resin matrix. Buffer tube 28 and strengthening members 29 are preferably extruded within an elastomeric jacket 31. As shown, jacket 31 has a non-cylindrical exterior, with generally flat, generally parallel sides 31a and rounded, such as semi-circular or elliptical, ends 31b. As such, cable 25 has a major axis dimension, as measured from one end 31b to the other end 31b, that is greater than a minor axis dimension, as measured from one side 31a to the other side 31a. In the preferred embodiment shown herein, the minor axis dimension is about one-half that of the major axis dimension. Also, the major axis dimension of cable 25 is slightly less than the depth of slot 17, and the minor axis dimension is slightly less than the width of slot 17.

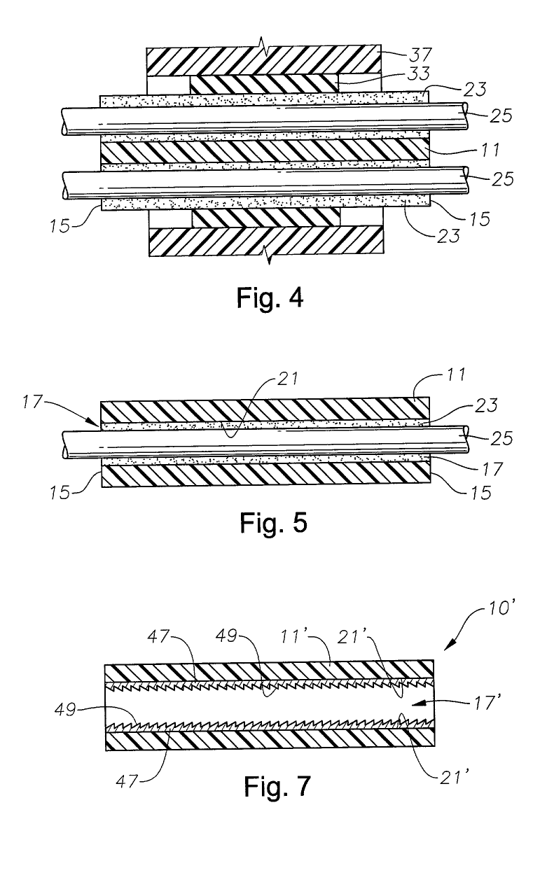

When cable 25 is positioned within slot 17, sealing substance 23 fills the void between sides 31a of cable 25 and side walls 21 of slot 17, fills the void between end 31b of cable 25 and base 19 of slot 17, and completely covers the end 31b of cable 25 adjacent the exterior 13 of adapter 10. Preferably, once cable 25 is installed as shown in FIGS. 2 and 4, sealing substance 23 flow entirely around cable 25 to the exterior 13 of adapter 10. As best shown in FIG. 2, a tubular seal 33 of an elastomeric material, such as a gasket or gel, extends around cylindrical exterior 13 of adapter 10. Seal 33 engages the interior surface of a cylindrical port 35 formed in wall 37 of an enclosure, such as the end wall of a splice closure, to form a tight fitting seal therebetween. Thus, port 35 will be slightly larger in diameter than the diameter of adapter 10. Seal 33 fills the void between the cylindrical exterior 13 of adapter 10 and the interior surface of the cylindrical port 35, and thereby seals the adapter 10 and the port 35 from deleterious conditions, such as weather, dirt, and insect and rodent infestations.

As shown in FIG. 4, the axial length of adapter 10 is preferably somewhat greater than the thickness of wall 37 and the length of seal 33. As a result, the ends 15 of adapter 10 protrude outwardly from each side of wall 37, although this is not essential. In contrast, seal 33 does not need to have a length as great as the thickness of wall 37. As shown, seal 33 has a length about one-half to two-thirds the thickness of wall 37.

FIG. 6 illustrates a conventional fiber optic splice closure 39 that may employ one or more adapters 10 positioned within ports 35 formed in wall 37 of the end cap of the splice closure 39. Adapters 10 are secured within one or more of the ports 35 of wall 37 for sealing feeder and/or drop cables, such as fiber optic cables 25 of the type shown in FIG. 3. Generally, the fiber optic cables 25 passing through adapters 10 will be employed as drop cables to extend service to certain subscribers from a main distribution and transmission feeder cable. During installation, the ends of the fiber optic cables 25 are stripped back, exposing buffer tubes 28. A frame 43 attaches to wall 37 for supporting one or more splice organizers 41. Various fiber optic buffer tubes 28, each containing one or more optical fibers, will be coiled about frame 43 with splices to the optical fibers of the feeder cable held in a splice organizer 41. A shroud 45 is placed over frame 43 and secured to the wall 37 of the end cap to enclose and protect the contents of the splice closure 39.

During manufacture of the drop cables 25, each slot 17 of the adapter 10 is filled with the sealing substance 23 to a point approximately one-half or more of the depth of the slot 17. The corresponding cable 25 is then positioned within the slot 17. Sealing substance 23 flows around and over cable 25, submerging cable 25 in sealing substance 23, as shown in FIG. 2. The tubular seal 33 is then formed around adapter 10, or within corresponding port 35, and the adapter 10 and/or seal 33 are positioned within port 35 formed in wall 37 of splice closure 39. Seal 33 will deform to form a sealing engagement between the cylindrical exterior 13 of adapter 10 and the interior surface of the cylindrical port 35 formed in wall 37. Preferably, there will be little or no deformation of adapter 10. Accordingly, slots 17 maintain the same dimensions that they had prior to installation of adapter 10 within port 35.

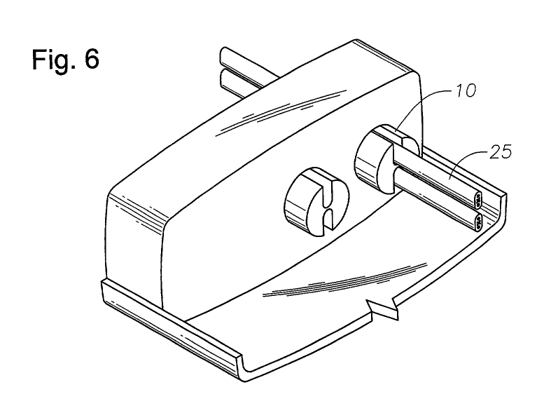

In a second preferred embodiment shown in FIG. 7, an adapter 10′ constructed in accordance with the invention further comprises teeth 49 located along each side wall 21′ of each slot 17′ formed in body 11′. Teeth 49 may have any desired configuration, and as shown have a saw tooth shape. Teeth 49 are employed to resist longitudinal movement of a cable 25 of the type that has an outer sheath (not shown). The distance between teeth 49 as measured from one side wall 21′ to the other is slightly less than the minor axis dimension of the cable 25 so that teeth 49 embed themselves in the outer sheath when the cable 25 is positioned within slot 17′. Preferably, teeth 49 are electrically conductive and formed on plates 47 that are attached to the side walls 21′ of slot 17′. Conductive plates 47 may be grounded, for example with a conventional grounding strap, so that the embedded teeth 49 ground a cable 25 of the type having a conductive, (e.g., metallic) inner sheath encased by a non-conductive outer sheath.

The invention has significant advantages. The adapter a cable having a non-cylindrical cross section to be sealed within a conventional cylindrical port formed in the wall of an enclosure, such a splice closure of a distribution and transmission network of a communications system. The adapter is simple in construction and is easy to use. Accordingly, one or more non-cylindrical drop cables may pass through the cylindrical ports formed in the end cap of an existing splice closure. While the invention has been shown and described in only two of its preferred forms, it should be apparent to those skilled in the art that it is not so limited, but it is susceptible to various alternative and additional embodiments without departing from the intended scope of the invention.

That which is claimed is:

1. An adapter for sealing a cable that has a non-cylindrical cross section within a cylindrical port, the adapter comprising:
a body defining a longitudinal axis and having a cylindrical exterior for sealingly engaging the port, the body having opposed ends and at least one longitudinal passage extending continuously between the opposed ends, the passage having a non-cylindrical cross section for receiving the cable therein.

2. The adapter according to claim 1 wherein the passage is configured to contain a sealing substance for sealing the cable within the passage.

3. The adapter according to claim 1 wherein the passage comprises a slot extending inwardly from the exterior of the body.

4. The adapter according to claim 3 wherein the passage has opposed side walls and a curved base opposite the exterior of the body.

5. The adapter according to claim 1 wherein the passage has opposed side walls, each of the side walls comprising a plurality of teeth for engaging the cable received within the passage.

6. The adapter according to claim 1 wherein the passage has a pair of opposed, substantially flat, generally parallel side walls and a rounded base extending between the side walls opposite the exterior of the body.

7. The adapter according to claim 6 wherein the base and each of the side walls defines a fillet radius therebetween.

8. The adapter according to claim 1 wherein the body is made of a substantially rigid material and the adapter further comprises a deformable seal for forming sealingly engaging the exterior of the body and the cylindrical port.

9. In a communications system enclosure having a wall with a cylindrical port formed therethrough and a cable passing through the port, the cable having a non-cylindrical cross section defining a major axis and a minor axis wherein the major axis is greater than the minor axis, the improvement comprising;
an adapter comprising a body defining a longitudinal axis and having a cylindrical exterior, the body having opposed ends and a continuous lengthwise passage extending between the ends;
a sealing substance located in the passage for sealing the cable within the body of the adapter; and
a deformable seal surrounding the body of the adapter for sealing the adapter within the port of the wall.

10. The enclosure according to claim 9 wherein the passage comprises a slot having opposed, generally parallel side walls and wherein the major axis of the cable is generally parallel with the opposed side walls of the slot.

11. The enclosure according to claim 9 wherein the slot extends inwardly from the exterior of the body of the adapter and comprises a curved base extending between the opposed side walls.

12. The enclosure according to claim 9 wherein the adapter is made of a substantially rigid material such that the passage maintains it cross section when the adapter is positioned within the port of the wall of the enclosure.

13. The enclosure according to claim 9 wherein the adapter defines a length measured between the opposed ends that is greater then the diameter of the adapter.

14. An adapter for sealing a plurality of cables within a cylindrical port, at least one of the plurality of cables having a non-cylindrical cross section, the adapter comprising:
a rigid body defining a longitudinal axis and having opposed ends, the body having a cylindrical exterior for sealingly engaging the inner surface of a port formed in a wall of an enclosure, the adapter having at least one lengthwise passage extending continuously between the opposed ends of the body for receiving the at least one cable having a non-cylindrical cross section; and
a tubular elastomeric seal surrounding the adapter for sealing the adapter within the port.

15. The adapter according to claim 14 wherein the passage of the body comprises a slot having opposed, generally flat, generally parallel side walls extending inwardly from the exterior of the body and a curved base extending between the side walls.

16. The adapter according to claim 14 wherein the passage of the body is partially filled with an elastomeric sealing substance that surrounds the at least one cable having the non-cylindrical cross section when the cable is received within the passage.

17. The adapter according to claim 14 wherein each of the passage has opposed side walls comprising a plurality of teeth for engaging the cable.

18. The adapter according to claim 14 wherein the body of the adapter defines a length measured between the opposed ends that is greater than the diameter of the body.

19. A method for sealing a cable that has a non-cylindrical cross section within a cylindrical port, the method comprising the steps of:
(a) positioning the cable within a passage formed in an adapter having a cylindrical exterior, the passage having a non-cylindrical cross section corresponding generally to the non-cylindrical cross section of the cable;
(b) sealing the cable positioned within the passage with an elastomeric sealing substance; and
(c) positioning the adapter within the cylindrical port and sealing the adapter and the port with a deformable seal that surrounds the cylindrical exterior of the adapter.

20. The method according to claim 19 wherein the step (a) comprises the further step of providing the passage of the adapter with a pair of opposed, generally parallel side walls that extend inwardly from the cylindrical exterior of the adapter and a curved base that extends between the side walls to thereby define an open radial slot in the cylindrical exterior of the adapter.
